(19) United States
(12) Patent Application Publication
(10) Pub. No.: US 2023/0063548 A1
(43) Pub. Date: Mar. 2, 2023

(54) CROSS-CHAIN TRANSACTION METHOD AND SYSTEM BASED ON HASH LOCKING AND SIDECHAIN TECHNOLOGY AND STORABLE MEDIUM

(71) Applicant: ZHEJIANG UNIVERSITY, Hangzhou (CN)

(72) Inventors: Yanjiao CHEN, Hangzhou (CN); Wenyuan XU, Hangzhou (CN); Yuyang RAN, Hangzhou (CN)

(73) Assignee: ZHEJIANG UNIVERSITY, Hangzhou (CN)

(21) Appl. No.: 17/857,072

(22) Filed: Jul. 4, 2022

(30) Foreign Application Priority Data
Aug. 31, 2021 (CN) 202111016061.3

(51) Int. Cl. H04L 9/00; H04L 9/32; G06F 9/52; G06Q 20/36

(52) U.S. Cl. CPC H04L 9/50; H04L 9/3218; H04L 9/3236; G06F 9/52; G06Q 20/3678; G06F 2209/521

(57) ABSTRACT

A cross-chain transaction method based on hash locking and a sidechain technology is provided. The cross-chain transaction method comprises the following steps: establishing a hash-locking-based atomic exchange data transmission mechanism for a first terminal and a second terminal; establishing a cross-chain data transfer mechanism based on an SPV pegging mode; and realizing, by the first terminal and the second terminal, a hash-locking-based atomic exchange data transmission under a supervision state of the SPV pegging mode. The cross-chain transaction method, by utilizing the sidechain technology, solves the defect of the hash locking technology that only asset exchange can be realized but asset transfer cannot be realized, and thus the cross-chain asset transfer can be realized by utilizing the hash locking technology without additionally adding a sidechain or a relay chain.

### CROSS REFERENCE TO THE RELATED APPLICATIONS

This application is based upon and claims priority to Chinese Patent Application No. 202111016061.3 filed on Aug. 31, 2021, the entire contents of which are incorporated herein by reference.

### TECHNICAL FIELD

The present invention relates to the field of blockchains, and in particular to a cross-chain transaction method and system based on hash locking and a sidechain technology and a storable medium.

### BACKGROUND

Nowadays, blockchain-based decentralized electronic money is becoming increasingly popular. All transactions are recorded on a blockchain, a common transaction ledger maintained by a set of decentralized peer nodes. With the development of technologies and the market, there are more and more kinds of cryptocurrencies, and simultaneously, a large number of different blockchains have emerged. Each chain is equivalent to an independent ledger, and value transfer usually cannot be realized between different ledgers. Collaborative operations and value circulation between different chains have become new requirements of users, so that the “cross-chain technology” of blockchains emerges at the right moment. Mainstream cross-chain technologies include a notary technology, a hash locking technology, and sidechain and relay chain technologies.

The notary technology, also known as the witness mechanism, is an intermediary approach. If a blockchain A and a blockchain B cannot directly interoperate, a common trusted third party can be introduced as an intermediary to verify and forward cross-chain information. Quite often, this notary/intermediary is an exchange. This technology has the advantage of supporting cross-chain interaction between blockchains with different configurations, and it has the defects that there's risk of centralization and only exchange can be realized but transfer cannot.

A typical implementation of hash locking is the Hashed Timelock Contract (HTLC). Hashed timelock skillfully adopts a hash lock and a time lock, so that an asset receiver is forced to acknowledge the receipt of payment within a certain time and generate a payment proof to a payer, and otherwise, the assets will be refunded to the payer. The payment proof can be used by the payer to obtain digital assets of equivalent value on the blockchain of the receiver or to trigger other events. Hash locking can only realize exchange but cannot realize asset transfer or information transfer, so that its use scene is limited.

The sidechain is used to refer to the blockchain that is parallel to the main blockchain. The main blockchain can be connected to the sidechain or connected by the sidechain; in this way, the sidechain can operate independently of the main blockchain (e.g., by using a spare record keeping approach). From the perspective of the mainchain as a single chain, the sidechain can virtually improve the performance of the mainchain transversely and longitudinally. By “transversely”, it means that a plurality of sidechains are interconnected with a mainchain, most transactions are performed on the sidechains and then transactions are communicated to the mainchain, so that the TPS of the mainchain can be virtually improved. By “longitudinally”, it means that the sidechain may have functions the mainchain does not have, and the mainchain seems to support these functions through the sidechain. Nowadays, the sidechains usually refer to pegged sidechains described by BlockStream. A pegged sidechain primarily refers to supporting two-way pegging of the assets, i.e., circulation of the assets between the mainchain and the sidechain. Currently, implementations of two-way pegged sidechains include the following 4 types.
1) Single escrow mode: The single escrow mode is the simplest method to implement two-way pegging, and its basic principle is same as a single notary mechanism. A transaction participant sends digital assets to an escrow party, and the escrow party sends the corresponding assets to a sidechain account of the counterparty on the sidechain.
2) Federated pegging mode: In federated pegging mode, a mode of notary alliance is used as an asset escrow party for federated pegging, and the risk of being monocentric is reduced by using a multi-signature mode.
3) Drive chain mode: The concept of drive chain is proposed by Paul, founder of Bitcoin Hivemind. In the drive chain, transaction processing nodes represent a role of a notary group and are responsible for funds escrow and unlocking. A transaction processing node submits asset locking information on other chains to the block and initiates a proposal, and after voting and confirmation, the specified assets on the current chain are unlocked.
4) SPV (Simple Payment Verification) pegging mode: It means that a light client is able to verify the existence of a certain transaction without downloading all the block data. An SPV proof contains two parts: a block header list, and a cryptographic proof representing that a certain output occurs in a certain block in the list, such as the Merkle proof. If a certain transaction is to be proved to exist in a certain block, the final Merkle tree root is calculated by using the hash value of this transaction and the hash values of other related transactions, and the final Merkle tree root is compared with the tree root in the block header. If the calculation result is consistent with the transaction tree root in the block header, the transaction is proved to exist in the block. Besides, relaying means that data of another chain can be verified on this chain by itself without relying on a third party.

### SUMMARY

In view of this, the present invention provides a cross-chain transaction method and system based on hash locking and a sidechain technology, and a storable medium. The present invention, by utilizing the sidechain technology, solves the defect of the hash locking technology that only asset exchange can be realized but asset transfer cannot be realized, and thus the cross-chain asset transfer can be realized by utilizing the hash locking technology without additionally adding a sidechain or a relay chain.

In order to achieve the above objective, the present invention adopts the following technical solutions:

provided is a cross-chain transaction method based on hash locking and a sidechain technology, comprising the following steps:

establishing a hash-locking-based atomic exchange data transmission mechanism for a first terminal and a second terminal;

establishing a cross-chain data transfer mechanism based on an SPV pegging mode; and

realizing, by the first terminal and the second terminal, hash-locking-based atomic exchange data transmission under a supervision state of the SPV pegging mode; wherein

a cross-chain transaction is performed between a first terminal user A on a chain A and a second terminal user B on a chain B, and the cross-chain transaction comprises the following steps:

generating, by the user A, a random number s and calculating a hash value H(s), wherein H represents a hash function;

locking, by the user A, a digital currency a required to be traded on the chain A by using the H(s) and a confirmation period, a locking time being t1;

sending, by the user A, the calculated H(s) to the user B and proving that the digital currency a to be traded is locked;

after the confirmation period of the chain A is passed, generating, by the user B, a coinbase transaction on the chain B and providing an SPV proof of a coin locking transaction on the chain A, wherein generated assets on the chain B are in a locked state and need to wait until a competition period is passed;

waiting on the chain B, by the user B, until the competition period is passed, wherein if the user A transfers coins locked on the chain A away during the competition period and other users use a latest SPV to prove the fact, the coinbase transaction on the chain B is invalid; and

after the competition period is passed, generating a digital currency on the chain b, and obtaining, by the user B, the generated digital currency by using the H(s).

Optionally, the atomic exchange data transmission mechanism comprises the following specific steps:

generating, by the user A, a random number and calculating a hash value of the random number;

generating, by the user A, a contract T1 at time t1 by using the hash value, and meanwhile, locking data required to be transmitted by the user A;

sending, by the user A, the hash value to the user B, and sending information to the user A to prove that the data required to be transmitted by the user A are locked;

generating, by the user B, a contract T2 at time t2 by using the hash value, and meanwhile, locking data required to be transmitted by the user B;

establishing, by the user A, a contract T3 by using the random number to unlock the contract T2, obtaining the data required to be transmitted by the user B, and meanwhile, exposing the random number; and

establishing, by the user B, a contract T4 by using the exposed random number to unlock the T1, and obtaining the data required to be transmitted by the user A.

Optionally, a principle of the atomic exchange data transmission mechanism is that two parties of data transmission parse internal data of the both parties through a hash value, and there is a time difference in timeout setting of hash locking.

Optionally, the cross-chain data transfer mechanism based on the SPV pegging mode is specifically as follows:

locking data of the user A and setting a confirmation period for locking the data of the user A;

after the confirmation period of the data of the user A is passed, generating, by the user B, a coinbase data transmission and providing an SPV proof of the coinbase data transmission of the user A, and meanwhile, locking generated data transmission information of the user B and waiting until a competition period is passed; and

after the competition period is passed, obtaining the data by the user B, and meanwhile, realizing the data transmission by the user B.

Optionally, if the data of the user A are lost during the competition period, a new SPV is adopted to prove that the data are lost, and the coinbase data transmission of the user B fails.

Provided is a cross-chain transaction system based on hash locking and a sidechain technology, comprising:

a mechanism establishment module, used for establishing a hash-locking-based atomic exchange data transmission mechanism for a first terminal and a second terminal, and for establishing a cross-chain data transfer mechanism based on an SPV pegging mode; and

a data transmission module, used for realizing, by the first terminal and the second terminal, hash-locking-based atomic exchange data transmission under a supervision state of the SPV pegging mode.

Provided is a computer storage medium, wherein the computer storage medium has a computer program stored thereon, and the computer program, when executed by a processor, implements the steps of the cross-chain transaction based on hash locking and the sidechain technology according to any one of the embodiments.

As can be seen from the above technical solutions, compared with the prior art, the present invention discloses and provides a cross-chain transaction method based on hash locking and a sidechain technology, wherein hash locking can only realize exchange but cannot realize asset transfer or information transfer, and both chains for asset exchange need to support a hash lock and a time lock, so that the use scene of hash locking is limited. The sidechain technology and the relay chain technology can be switched between the mainchain and the sidechain, so that the privacy can be improved, the cost can be reduced, and the value transfer and settlement processes can be accelerated. However, the sidechain technology also has the defect that there must be a sidechain or a relay chain and thus, indirectly, an additional third party is present in the cross-chain process. Aiming at the defects of the existing hash-locking-based cross-chain technology and sidechain cross-chain technology, the present invention directly generates new digital currency within the hash locking time period, thereby realizing the cross-chain atomic transaction; in addition, without the participation of a sidechain or a relay chain, the problems in throughput and transaction speed of public chain transaction are solved and thus the expansibility of a public chain is improved.

### BRIEF DESCRIPTION OF THE DRAWINGS

In order to more clearly illustrate the technical solutions in the embodiments of the present invention or in the prior art, the drawings required to be used in the description of the embodiments or the prior art are briefly introduced below. It is obvious that the drawings in the description below are some embodiments of the present invention, and those of ordinary skilled in the art can obtain other drawings according to the drawings provided herein without creative efforts.

FIG. 1 shows a schematic diagram of a hash-locking-based atomic transaction according to the present invention; and

FIG. 2 shows the two-way pegging in an SPV mode according to the present invention.

### DETAILED DESCRIPTION OF THE EMBODIMENTS

The technical solutions in the embodiments of the present invention will be clearly and completely described below with reference to the drawings in the embodiments of the present invention, and it is obvious that the described embodiments are only a part of the embodiments of the present invention but not all of them. Based on the embodiments of the present invention, all other embodiments obtained by those of ordinary skilled in the art without creative efforts fall within the protection scope of the present invention.

The embodiments of the present invention disclose a cross-chain transaction method and system based on hash locking and a sidechain technology, and a storable medium, wherein the method comprises the following steps:

Step 1, realizing a hash-locking-based atomic exchange.

The hash-locking-based atomic exchange can ensure the safety and atomicity of asset transactions between different chains without the participation of a third party. Hashed timelock skillfully adopts a hash lock and a time lock, so that an asset receiver is forced to acknowledge the receipt of payment before a deadline and generate a payment proof to a payer, and otherwise, the assets will be refunded to the payer. The payment proof can be used by the payer to obtain digital assets of equivalent value on the blockchain of the receiver or to trigger other events.

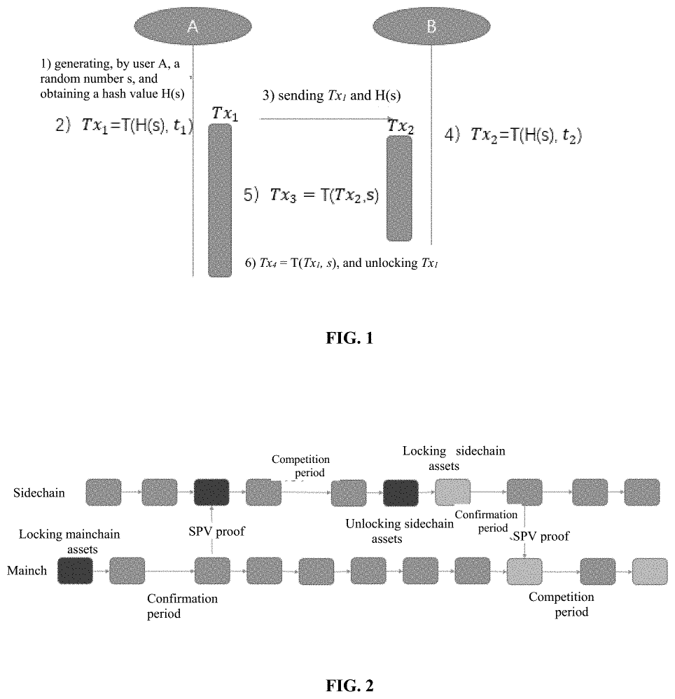

As shown in FIG. 1, the atomic exchange hash lock mechanism for users A and B can be described simply as follows (assume that user A uses digital currency a on chain A to exchange digital currency b on chain B with user B, where the digital currency is issued by the central bank.)

1) generating, by the user A, a random number s and calculating a hash value H(s), wherein H represents a hash function;

2) generating, by the user A, a contract transaction T (H(s), t1) on the chain A by using H(s) and a time period, and locking a digital currency a required to be traded on the chain A, a locking time being t1;

3) sending, by the user A, the calculated H(s) to the user B and sending the transaction to the chain A, and proving that the digital currency a to be traded is locked;

4) generating, by the user B, a contract transaction by using the H(s) and a time period, and locking a digital currency b required to be traded and putting the transaction on the chain, a locking time being (<);

5) establishing, by the user A, a contract by using the s to unlock the locked transaction on the chain B, and obtaining the locked digital currency b, wherein at this point the random number s is exposed; and

6) establishing, by the user B, a contract by using the public s to unlock the locked transaction on the chain A, and obtaining the locked digital currency a.

In the above steps, the hash function is also called the hash, which is a method for establishing a small digital “fingerprint” from any kind of data. The hash compresses information or data into a digest so that the volume of data becomes small and the format of data is fixed. This function mixes the data and reestablishes a fingerprint called a hash value. The hash value is typically represented by a short character string of random letters and numbers. As can be seen from the above process, the hashed timelock contract has some constraints, one of which is that both parties must be able to parse internal data of the contracts of the two parties, such as s and asset locking proof, and the other of which is that there must be a time difference in timeout setting of hash locking, so that the one party can withdraw its own assets in time when the other party is cheating.

Hash locking of assets can be accomplished by establishing HTLCs. Assuming that the two transaction parties are A and B, A needs two UTXOs to establish an HTLC. The user A firstly generates a random number s and calculates H(s), wherein only when a preimage s is provided can H(s) be calculated to realize hash locking. Then, the user A generates one UTXO and sends a certain amount of digital currency to a digital currency script, and the two spending conditions of the UTXO set in the script are as follows: 1) providing a signature and the preimage s of the user B; and 2) providing signatures of the users A and B. This transaction is commonly referred to as a fund transaction and indicates the locking of the assets. The user A generates another transaction, the fund transaction is used as an input of a second UTXO, an address of the user A is output, and meanwhile, the nTimeLock field is set as Tlock, which indicates that the packed transaction is allowed to be valid after T is reached, and thus time locking is realized, so that this transaction is called a redeem transaction. The user A sends these two transactions to the user B, and the user B, if he/she agrees, signs the second transaction and sends it back to the user A. For a Turing-complete chain, a contract may be generated. The contract logic is set as follows: during time t (implementing a time lock), if the address of the user A can provide a hash preimage s (implementing a hash lock), the assets locked in the contract can be taken and assets required to be locked then are sent to the contract.

Step 2, performing cross-chain asset transfer based on the SPV pegging mode, as shown in FIG. 2.

The SPV mode means that by sending a transaction to a special address on the mainchain, an SPV proof is automatically established for the sidechain, and a transaction is initiated to unlock the corresponding assets on the sidechain. Assuming that asset transfer is performed between the chain A and the chain B, cross-chain payment has the following steps:

1) locking assets of chain A, which may be realized by using a multi-signature account;

2) waiting on the chain A until a confirmation period is passed, which may be one or two days, so as to ensure that enough work is generated and thus to resist denial-of-service attacks;

3) after the confirmation period of the chain A is passed, generating, by the user, a coinbase transaction on the chain B and providing an SPV proof of a coin locking transaction on the chain A, wherein generated assets on the chain B are in a locked state and need to wait until a competition period is passed;

4) waiting on the chain B, by the user, until a competition period is passes, the competition period being set to prevent double spending; wherein, if the user transfers coins locked on the chain A away during the competition period and other users use a latest SPV to prove the fact, the coinbase transaction on the chain B is invalid, and this proof is called a reorganization proof;

5) after the competition period is passed (about 1 to 2 days), generating a digital currency on the chain B, which can be circulated on the chain B; and

6) returning the digital currency of the chain B to the chain A, and repeating the above 5 steps.

Step 3, realizing a cross-chain transaction based on hash locking and the SPV pegging mode.

Assuming that a cross-chain transaction is performed between the user A on the chain A and the user B on the chain B, the cross-chain transaction has the following steps:

1) generating, by the user A, a random number s and calculating a hash value H(s), wherein H represents a hash function;

2) locking, by the user A, a digital currency a required to be traded on the chain A by using the H(s) and a confirmation period, a locking time being t1;

3) sending, by the user A, the calculated H(s) to the user B and proving that the digital currency a to be traded is locked;

4) after the confirmation period of the chain A is passed, generating, by the user B, a coinbase transaction on the chain B and providing an SPV proof of a coin locking transaction on the chain A, wherein generated assets on the chain B are in a locked state and need to wait until a competition period is passed;

5) waiting on the chain B, by the user B, until a competition period (<) is passed; wherein, if the user A transfers coins locked on the chain A away during the competition period and other users use a latest SPV to prove the fact, the coinbase transaction on the chain B is invalid, and this proof is called a reorganization proof; and

6) after the competition period is passed, generating a digital currency on the chain B, and obtaining, by the user B, the generated digital currency by using the H(s).

Specifically, the present invention is mainly based on the blockchain technology and utilizes the sidechain technology to solve the defect of the hash locking technology that only asset exchange can be realized but asset transfer cannot be realized, and thus the cross-chain asset transfer can be realized by utilizing the hash locking technology without additionally adding a sidechain or a relay chain. The technical solutions in the embodiments of the present invention will be clearly and completely described below.

Step 1, establishing a hash-locking-based transaction

In the embodiment of the present invention, a user Alice uses 1 digital currency m to exchange 50 digital currencies n with a user Bob, and a cross-chain transaction process is as follows:

1. randomly establishing, by Alice, a character string s, and calculating a hash value h(s) of the character string s;

2. sending, by Alice, the h(s) to Bob;

3. locking, by Alice, the 1 digital currency m asset through a contract, setting a relatively long locking time, and then setting conditions for obtaining the digital currency m, wherein Bob provides an original value s of the h(s);

4. locking, by Bob, the 50 digital currencies n to his contract, and setting a relatively short locking time (<); and then setting conditions for obtaining the 50 digital currencies n, wherein Alice provides an original value s of the h(s);

5. sending, by Alice, the character string s to the contract of Bob to obtain the 50 digital currencies n;

6. noticing, by Bob, the s value of Alice in the step 5, and sending the s value to the contract of Alice to successfully obtain the 1 digital currency m, thereby completing the asset exchange; and

7. if there is timeout, retuning the locked assets to the original owner.

Step 2, performing cross-chain asset transfer based on the SPV pegging mode

In the embodiment of the present invention, the 1 digital currency m on the chain a of an user is transferred to a chain b and becomes the 50 digital currencies n.

1) locking the 1 digital currency m on the chain a, which may be realized by using a multi-signature account;

2) waiting on the chain a until a confirmation period is passed, time being t1, so as to ensure that enough work is generated and thus to resist denial-of-service attacks;

3) after the confirmation period of the chain a is passed, generating, by the user, a coinbase transaction on the chain b and providing an SPV proof of a coin locking transaction on the chain a, wherein generated assets on the chain b are in a locked state and need to wait until a competition period is passed; and

4) waiting on the chain b, by the user, until the competition period is passed (so as to prevent double spending); wherein, if the user transfers coins locked on the chain a away during the competition period and other users use a latest SPV to prove the fact, the coinbase transaction on the chain b is invalid, and this proof is called a reorganization proof;

wherein, when an a-chain network needs to use the SPV to perform a simple payment verification, the steps are as follows:

1) calculating a transaction hash value of the payment to be verified; and obtaining, by nodes, all block headers of a longest chain from a blockchain network and storing to the local;

2) obtaining from the blockchain, by the nodes, a Merkle tree hash authentication path corresponding to the payment to be verified;

3) calculating a root hash value of the Merkle tree according to the hash authentication path, comparing a calculation result with a root hash value of the Merkle tree in the local block header, and positioning this block header to a block containing the payment to be verified; and

4) verifying whether the block header of the block is contained in the longest known chain or not according to the position of the block header, and determining a confirmation amount that the payment has obtained, wherein if it is contained in the longest known chain, the payment is proved to be true and valid.

Step 3, realizing a cross-chain transaction based on hash locking and the SPV pegging mode

Assuming that a cross-chain transaction is performed between the user Alice on the chain a and the user Bob on the chain b, the cross-chain transaction has the following steps:

1) generating, by the user Alice, a random number s and calculating a hash value H(s), wherein H represents a hash function;

2) locking, by the user Alice, a digital currency a required to be traded on the chain a by using the H(s) and a confirmation period, a locking time being t1;

3) sending, by the user Alice, the calculated H(s) to the user Bob and proving that the digital currency a to be traded is locked;

4) after the confirmation period of the chain a is passed, generating, by the user B, a coinbase transaction on the chain b and providing an SPV proof of a coin locking transaction on the chain a, wherein generated assets on the chain b are in a locked state and need to wait until a competition period is passed;

5) waiting on the chain b, by the user B, until a competition period (<) is passed; wherein, if the user A transfers coins locked on the chain a away during the competition period and other users use a latest SPV to prove the fact, the coinbase transaction on the chain b is invalid, and this proof is called a reorganization proof; and

6) after the competition period is passed, generating a digital currency on the chain b, and obtaining, by the user B, the generated digital currency by using the H(s);

wherein, when an a-chain network needs to use the SPV to perform a simple payment verification, the steps are as follows:

1) calculating a transaction hash value of the payment to be verified; and obtaining, by nodes, all block headers of a longest chain from a blockchain network and storing to the local;

2) obtaining from the blockchain, by the nodes, a Merkle tree hash authentication path corresponding to the payment to be verified;

3) calculating a root hash value of the Merkle tree according to the hash authentication path, comparing a calculation result with a root hash value of the Merkle tree in the local block header, and positioning this block header to a block containing the payment to be verified; and

4) verifying whether the block header of the block is contained in the longest known chain or not according to the position of the block header, and determining a confirmation amount that the payment has obtained, wherein if it is contained in the longest known chain, the payment is proved to be true and valid.

Provided is a cross-chain transaction system based on hash locking and a sidechain technology, comprising:

a mechanism establishment module, used for establishing a hash-locking-based atomic exchange data transmission mechanism for a first terminal and a second terminal, and for establishing a cross-chain data transfer mechanism based on an SPV pegging mode; and

a data transmission module, used for realizing, by the first terminal and the second terminal, hash-locking-based atomic exchange data transmission under a supervision state of the SPV pegging mode.

Provided is a computer storage medium, wherein the computer storage medium has a computer program stored thereon, and the computer program, when executed by a processor, implements the steps of the cross-chain transaction based on hash locking and the sidechain technology.

The above description of the disclosed embodiments enables those skilled in the art to implement or use the present invention. Various modifications to these embodiments will be readily apparent to those skilled in the art, and the generic principles defined herein may be applied to other embodiments without departing from the spirit or scope of the present invention. Thus, the present invention is not intended to be limited to the embodiments shown herein but is to be accorded the broadest scope consistent with the principles and novel features disclosed herein.

1. A cross-chain transaction method based on hash locking and a sidechain technology, comprising the following steps:
establishing a hash-locking-based atomic exchange data transmission mechanism for a first terminal and a second terminal;
establishing a cross-chain data transfer mechanism based on an SPV pegging mode; and
realizing, by the first terminal and the second terminal, a hash-locking-based atomic exchange data transmission under a supervision state of the SPV pegging mode; wherein
a cross-chain transaction is performed between a first terminal user A on a chain A and a second terminal user B on a chain B, and the cross-chain transaction comprises the following steps:
generating, by the first terminal user A, a random number s and calculating a hash value H(s), wherein H represents a hash function;
locking, by the first terminal user A, a first digital currency a required to be traded on the chain A by using the H(s) and a confirmation period, a locking time being t1;
sending, by the first terminal user A, the calculated H(s) to the second terminal user B and proving that the first digital currency a to be traded is locked;
after the confirmation period of the chain A is passed, generating, by the user B, a coinbase transaction on the chain B and providing an SPV proof of a coin locking transaction on the chain A, wherein generated assets on the chain B are in a locked state and need to wait until a competition period is passed;
waiting on the chain B, by the second terminal user B, until the competition period is passed, wherein if the first terminal user A transfers coins locked on the chain A away during the competition period and other users use a latest SPV to prove a fact, the coinbase transaction on the chain B is invalid; and
after the competition period is passed, generating a second digital currency on the chain B, and obtaining, by the second terminal user B, the generated second digital currency by using the H(s).

2. The cross-chain transaction method based on hash locking and a sidechain technology according to claim 1, wherein the hash-locking-based atomic exchange data transmission mechanism comprises the following specific steps:
generating, by the first terminal user A, a random number and calculating a hash value of the random number;
generating, by the first terminal user A, a contract T1 at time t1 by using the hash value, and meanwhile, locking data required to be transmitted by the first terminal user A;
sending, by the first terminal user A, the hash value to the second terminal user B, and sending information to the user A to prove that the data required to be transmitted by the first terminal user A are locked;
generating, by the second terminal user B, a contract T2 at time t2 by using the hash value, and meanwhile, locking data required to be transmitted by the second terminal user B;
establishing, by the first terminal user A, a contract T3 by using the random number to unlock the contract T2, obtaining the data required to be transmitted by the second terminal user B, and meanwhile, exposing the random number; and
establishing, by the second terminal user B, a contract T4 by using the exposed random number to unlock the T1, and obtaining the data required to be transmitted by the first terminal user A.

3. The cross-chain transaction method based on hash locking and a sidechain technology according to claim 1, wherein a principle of the atomic exchange data transmission mechanism is that two parties of data transmission parse internal data of the two parties through a hash value, and there is a time difference in timeout setting of hash locking.

4. The cross-chain transaction method based on hash locking and a sidechain technology according to claim 1, wherein the cross-chain data transfer mechanism based on the SPV pegging mode is specifically as follows:
locking data of the first terminal user A and setting a confirmation period for locking the data of the first terminal user A;
after the confirmation period of the data of the first terminal user A is passed, generating, by the second terminal user B, a coinbase data transmission and providing an SPV proof of the coinbase data transmission of the first terminal user A, and meanwhile, locking generated data transmission information of the second terminal user B and waiting until the competition period is passed; and
after the competition period is passed, obtaining the data by the second terminal user B, and meanwhile, realizing the data transmission by the second terminal user B.

5. The cross-chain transaction method based on hash locking and a sidechain technology according to claim 4, wherein if the data of the first terminal user A are lost during the competition period, a new SPV is adopted to prove that the data are lost, and the coinbase data transmission of the second terminal user B fails.

6. A cross-chain transaction system based on hash locking and a sidechain technology, comprising:
a mechanism establishment module, used for establishing a hash-locking-based atomic exchange data transmission mechanism for a first terminal and a second terminal, and for establishing a cross-chain data transfer mechanism based on an SPV pegging mode; and
a data transmission module, used for realizing, by the first terminal and the second terminal, hash-locking-based atomic exchange data transmission under a supervision state of the SPV pegging mode; wherein
a cross-chain transaction is performed between a first terminal user A on a chain A and a second terminal user B on a chain B, and the cross-chain transaction comprises the following steps:
generating, by the first terminal user A, a random number s and calculating a hash value H(s), wherein H represents a hash function;
locking, by the first terminal user A, a first digital currency a required to be traded on the chain A by using the H(s) and a confirmation period, a locking time being t1;
sending, by the first terminal user A, the calculated H(s) to the second terminal user B and proving that the first digital currency a to be traded is locked;
after the confirmation period of the chain A is passed, generating, by the second terminal user B, a coinbase transaction on the chain B and providing an SPV proof of a coin locking transaction on the chain A, wherein generated assets on the chain B are in a locked state and need to wait until a competition period is passed;
waiting on the chain B, by the second terminal user B, until the competition period is passed, wherein if the first terminal user A transfers coins locked on the chain A away during the competition period and other users use a latest SPV to prove a fact, the coinbase transaction on the chain B is invalid; and
after the competition period is passed, generating a second digital currency on the chain B, and obtaining, by the second terminal user B, the generated second digital currency by using the H(s).

7. A computer storage medium, wherein the computer storage medium has a computer program stored thereon, and the computer program, when executed by a processor, implements the steps of the cross-chain transaction method based on the hash locking and the sidechain technology according to claim 1.

8. The computer storage medium according to claim 7, wherein in the cross-chain transaction method, the hash-locking-based atomic exchange data transmission mechanism comprises the following specific steps:
generating, by the first terminal user A, a random number and calculating a hash value of the random number;
generating, by the first terminal user A, a contract T1 at time t1 by using the hash value, and meanwhile, locking data required to be transmitted by the first terminal user A;
sending, by the first terminal user A, the hash value to the second terminal user B, and sending information to the user A to prove that the data required to be transmitted by the first terminal user A are locked;
generating, by the second terminal user B, a contract T2 at time t2 by using the hash value, and meanwhile, locking data required to be transmitted by the second terminal user B;
establishing, by the first terminal user A, a contract T3 by using the random number to unlock the contract T2, obtaining the data required to be transmitted by the second terminal user B, and meanwhile, exposing the random number; and
establishing, by the second terminal user B, a contract T4 by using the exposed random number to unlock the T1, and obtaining the data required to be transmitted by the first terminal user A.

9. The computer storage medium according to claim 7, wherein in the cross-chain transaction method, a principle of the atomic exchange data transmission mechanism is that two parties of data transmission parse internal data of the two parties through a hash value, and there is a time difference in timeout setting of hash locking.

10. The computer storage medium according to claim 7, wherein in the cross-chain transaction method, the cross-chain data transfer mechanism based on the SPV pegging mode is specifically as follows:
locking data of the first terminal user A and setting a confirmation period for locking the data of the first terminal user A;
after the confirmation period of the data of the first terminal user A is passed, generating, by the second terminal user B, a coinbase data transmission and providing an SPV proof of the coinbase data transmission of the first terminal user A, and meanwhile, locking generated data transmission information of the second terminal user B and waiting until the competition period is passed; and
after the competition period is passed, obtaining the data by the second terminal user B, and meanwhile, realizing the data transmission by the second terminal user B.

11. The computer storage medium according to claim 10, wherein in the cross-chain transaction method, if the data of the first terminal user A are lost during the competition period, a new SPV is adopted to prove that the data are lost, and the coinbase data transmission of the second terminal user B fails.
